(19) United States
(12) Patent Application Publication
(10) Pub. No.: US 2019/0172335 A1
(43) Pub. Date: Jun. 6, 2019

(54) WEARABLE TRANSPONDER ALERT AND MONITORING SYSTEM

(71) Applicant: Kayla Simone JOHNSTON-MITCHELL, Bloomfield Hills, MI (US)

(72) Inventor: Kayla Simone JOHNSTON-MITCHELL, Bloomfield Hills, MI (US)

(21) Appl. No.: 16/324,376

(22) PCT Filed: Aug. 7, 2017
(86) PCT No.: PCT/US17/00044

§ 371 Date: Feb. 8, 2019

Related U.S. Application Data
(60) Provisional application No. 62/494,402, filed on Aug. 8, 2016.

(51) Int. Cl. G08B 21/04; H04M 11/04; G08B 21/18; H04W 4/029

(52) U.S. Cl. CPC G08B 21/0453; H04W 4/029; G08B 21/182; H04M 11/04

(57) ABSTRACT

A wearable personal safety device includes a housing unit having skin contact and including a radio frequency transponder configured to receive, from a mobile communication device, an initiating signal including a unique user identifier and establish a connection therewith, the transponder being configured to detect biometric and physiological parameter values of the skin, memory configured to store data indicative of the detected biometric and physiological parameter values, a rechargeable battery, and a processor configured to, in response to one of the detected biometric and physiological parameter values not meeting a corresponding threshold, cause the transponder to send to the communication device a request, including the unique identifier, to issue a personal emergency alert.

### TECHNICAL FIELD

Radio Frequency Identification Device (RFID) systems typically have three components: transponders (tags), cooperating wireless radio frequency antennae(s) (reader or interrogator) and a communications (software) system. When the transponder signal is within range of the cooperating wireless radio frequency antennae(s) its reads/interrogates information and data from the transponder and saves/stores the data and information in a communications system.

### BACKGROUND ART

Wearable portable devices are widely available as fitness trackers, medical device monitors, help panic buttons, and criminal tracking. Most devices can be wirelessly connected to communications systems or devices. Typically, monitoring (software enabled) systems enable the transponder and cooperating antenna (reader or interrogator) to exchange and to store data and information received from the transponder and later accessed, analyzed and/or viewed, such as software used to view information from medical alert devices, fitness and activity trackers. A few devices will signal a communications dispatch to route and manage emergency events.

Wave radio antennae frequency technology is widely used to track and to detect aircraft, inventory management in a warehouse environment, and to process transactions from vehicles passing through toll roads antennae systems. The radio frequency is used on Aircraft. When antenna radio towers receive the transponder signal the transponders identify encoded information about the aircraft. Toll roads (e.g. easy pass lanes) use transponders to identify encoded information on motor vehicles equipped with transponders that pass within short-range of the reader/interrogator radio antennae to justify fees and processing transactions for billing and collecting payments. Radio antennae receivers are key components used in RFID systems, as well as being manufactured in devices for personal use, such as mobile phone, smart watches, laptops/PCs, tablets and motor vehicles. Transponder signals are used in vehicle key fobs to signal actions: locking and unlocking the vehicle doors or activating the alarm system.

### DISCLOSURE OF INVENTION

This Patent Cooperation Treaty (PCT) WEARABLE TRANSPONDER(S), ALERT AND MONITORING SYSTEM application claims the benefit of the filing date under 35 U.S.C. 119(e) of Provisional U.S. Patent Application Ser. No. 62/494,402 filed on Aug. 8, 2016, which is hereby incorporated in the Reference section of this application. This PCT application is filed to preserve the disclosure of the invention filed in the provisional patent, to benefit from the priority date and to avoid abandonment.

The invention disclosed in this PCT is a personal/public network of communication systems (software and/or interfaces) for personal wearables transponder(s), alert and monitoring system, that when the transponders (tags) are within signal range and strength of a cooperating wireless antennae radio receiver device (reader/interrogator) they can be read/interrogated for the benefit of the wearer in the event of a personal safety event. The user of the system can wear the transponder(s) in a manufactured device, such as apparatuses worn on the wrist, neck, ankle, back, shoulder, waist and/or clothing or shoes, while within range of a cooperating wireless antennas radio receiver in a mobile communication system and device, such as a smart phone, smart watch, smart tablet, PC/laptop, and/or home, having been embedded software and interfaces, creates a personal safety alert and monitoring system that can be accessed to respond in the event of potential threats and/or emergencies (environmental, medical and/or physical).

When the wearable transponder(s) is within range and having adequate signal strength it signals will be reader/interrogator by a wireless radio frequency antennae(s) device in a communications system (software and/or interface). In real-time or interval the transponder(s) signal is monitored and detected by the reader/interrogator for data and information from the transponder(s) that can be captured and stored in the communications system (software and/or interface), such as the wearer's whereabouts (e.g. date, time, time zone, temperature, coordinates, etc.) and other calculated information, such as the wearer's distance traveled, the travel time between distances, the length of stay at a location (arrival and departure), map coordinates and . For the purposes of an emergency, this information can be used by emergency services to locate the wearer and dispatch emergency services to expedite and coordinate a response. More enriched analysis can be performed using the data and information the wear stored in the mobile communication system embedded with a reader/interrogator, such as contacts, calendar notifications, last telephone numbers dialed or text messages sent/received, medications, medical history, blood type, allergies, disabilities, etc.

The communications system can activate outgoing responses from the wearer, using text messaging and/or voice activated dialing and using the communications system and the cooperating wireless radio frequency antennae(s). The communications system can activate/deactivate a series of preset automatic actions (such as text messaging/emailing contacts) in the communications system of the cooperating wireless antennae radio receiver device that automatically continue and repeat until a response is received. These preset automatic actions and responses to an unresponsive wearer will continue and repeat as often as the communication system functions. The wearer can set automatic action(s) to prompt/alert the wearer or a network of responders, using the mobile communications system device of the wireless radio frequency antennae(s), such as dial “911” and transmit the last location data and information of the wearer or automatically action a series of communications.

The provisional patent application 62/494,402 for which the PCT claims priority was the result of market research on wearable device and interviews with potential users of wearable devices, as well as reviews of patent applications and patents issued. There is a preliminary disclosure of the patent applications and patent issues that were reviewed and formed the basis of this PCT application. These reviews provided an understanding of new advancements in wearables—particularly those having the same purposes as the invention disclosed in this PCT application. Of the more than ten (10) patent citations listed in the Patent Citation section of this PCT application, there are three (3) with the same focus, personal safety alert and monitoring. Below is a preliminary assessment of the similarities and differences.

A U.S. patent application by Apple for ‘care events’ was filed, based on a Mar. 10, 2016 article, Apple Invents new iPhone ‘Event Care’ Alert System that Could Automatically Call for Assistance in Emergencies, published on http://www.patentlyapplce.com. In this article it states, “a patent application from Apple that generally relates to ‘care events’ and more specifically to detection of care events and transmission of alerts to iOS devices regarding detected care events . . . If the device, such as an iPhone, detects that a user is in trouble and is currently unable to use their device to call for help, the ‘care event’ feature of the iPhone would kick into gear automatically and dial out for assistance to emergency services . . . ” Apple's ‘care event’ device operates on its iOS systems, such as an iPhone and/or other Apple manufactured device, which is the backbone of the ‘care event’ system in cooperation with the user's data and environmental sensors. “Apple's invention covers systems, methods and apparatuses for providing alerts and regarding a care event. An occurrence of one or more “care events” may be detected by an electronic device monitoring environmental data and/or user data from one of more sensors.” Whereas this PCT application does not rely on information ‘detected by an electronic device monitoring environmental data and/or user data from one of more sensors.’ However, like Apple's ‘care events’ system, the invention disclosed in this PCT application can “. . . cover a user in a car accident, a user having a heart attack during a workout, a dementia patient drifting too far from a care center or home, a skier caught in an avalanche and beyond.”

The invention disclosed in this PCT application uses transponder signals and a cooperating a radio frequency device reader/interrogator that can detect signal strength and measure signal range from/between the transponder and the reader to indicate the potential user distresses (whether caused by environmental, medical or physical or accidental). Also unlike the Apple ‘care event’ system, the invention disclosed in this

PCT application does not detect any events. It merely recognizes system behaviors associated with distress, i.e. failure to respond to a recognized system alert. The user must be adequately trained on the system's alert parameters to avoid false alerts. The second patent with the same focus, as this PCT application, is an Apple patent application from 2014. According to an article in TechCrunch (https://techcrunch.com/2014/03/06/apple-patents-built-in-automated-emergency-detection-and-assistance-for-iphone/) uses “. . . data from onboard sensors to automatically detect when a user is subject to physically attack, including car crashes, and violent personal altercations, as well as sudden emergencies. Once the iPhone uses information from those sensors, which include contact detection to determine if someone is suddenly separated from their device in the middle of an interaction, or if a user doesn't move for an extended period of time in unusual circumstances.” Whereas the system disclosed in this PCT application is unrestricted to an onboard sensor in a device, such as an iPhone, it does detect ‘if someone is suddenly separated from their device’, by using transponder signals and a cooperating wireless radio frequency antennae(s) communications system device that detects signal strength and measure signal range from/between the transponder and the cooperating wireless radio frequency antennae(s) to indicate a sudden separation (maybe by an unresponsive user and her/his potential user distresses, whether caused by environmental, medical or physical or accidental). Like the Apple ‘emergency detection’ system, the invention disclosed in this PCT application does not detect the cause or the kind of event. It merely recognizes that the user is unresponsive, i.e. failure to respond to a recognized system alert. The user must be adequately trained on the system's alert parameters to avoid false alerts.

The third and final patent with the same focus, as this PCT application, is an Apple patent application on fingerprint 911. According to an article from Money CNN (http://money.cnn.com/2017/07/18/technology/apple-patent-fingerprint-911/index.html) Apple iPhones enable users to conceal a call to emergency services by pressing down on the fingerprint touch pad portion on the face of the iPhone, avoiding unlocking the iPhone or revealing that the user is/has contacted emergency services. Whereas, system disclosed in this PCT application, enables the user to conceal contacting emergencies in two (2) ways: by ignoring the systems alert prompts and/or by pressing a transponder button concealed in the manufactured wearable

### BRIEF DESCRIPTION OF THE DRAWINGS

Reference will now be made to the accompanying drawings, which form part of, and which show, by way of process diagrams.

FIG. 1 When the cooperating wireless antennae radio (read/interrogator) device and the wearable transponders are successfully signaling/operating within the programmed signal range and signal the unique signal(s)/unique identifier(s), where data and information programmed in the signals is being transmitted and received and were the communications system (software and/or interface) is reading/writing/saving/storing the data and information in real-time or intermittently for the readiness of the wearer's communication network to aid and to respond in the event of a personal safety event(s).

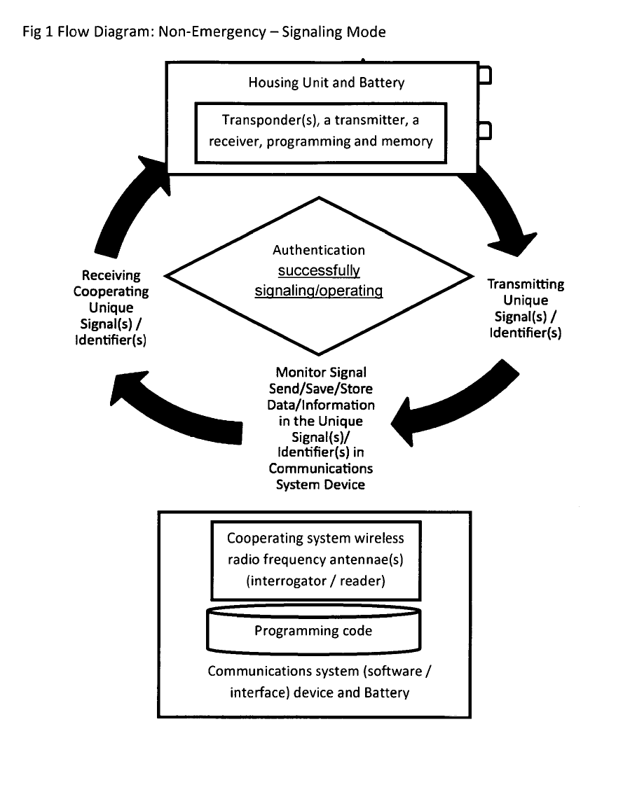

FIG. 2 When the cooperating wireless antennae radio (read/interrogator) device and the wearable transponders are successfully signaling/operating within the programmed signal range and signal the unique signal(s)/unique identifier(s), where data and information programmed in the signals is being transmitted and received and were the communications system (software and/or interface) is reading/writing/saving/storing the data and information in real-time or intermittently, where the wearer has a medical emergency while conscious and pressing the medical button on the wearable transponder to transmit a priority signal to the wearer's communication network to aid and to respond in the event of a personal safety event(s), such as sending outgoing system actions/activities enabled in the communications system device.

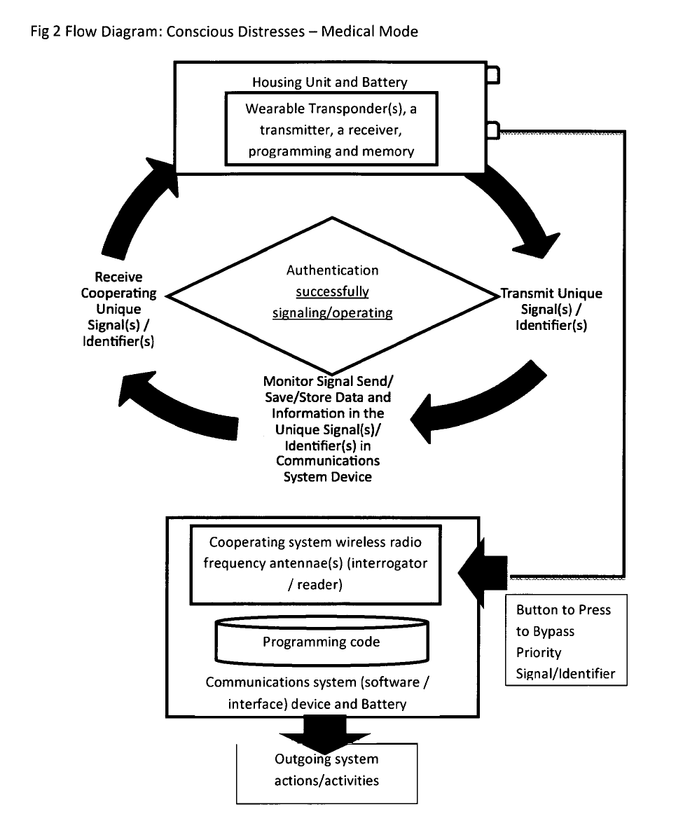

FIG. 3 When the cooperating wireless antennae radio (read/interrogator) device and the wearable transponders are successfully signaling/operating within the programmed signal range and signal the unique signal(s)/unique identifier(s), where data and information programmed in the signals is being transmitted and received and were the communications system (software and/or interface) is reading/writing/saving/storing the data and information in real-time or intermittently, where the wearer has a physical emergency while conscious and pressing the medical button on the wearable transponder to transmit a priority signal to the wearer's communication network to aid and to respond in the event of a personal safety event(s), such as sending outgoing system actions/activities enabled in the communications system device.

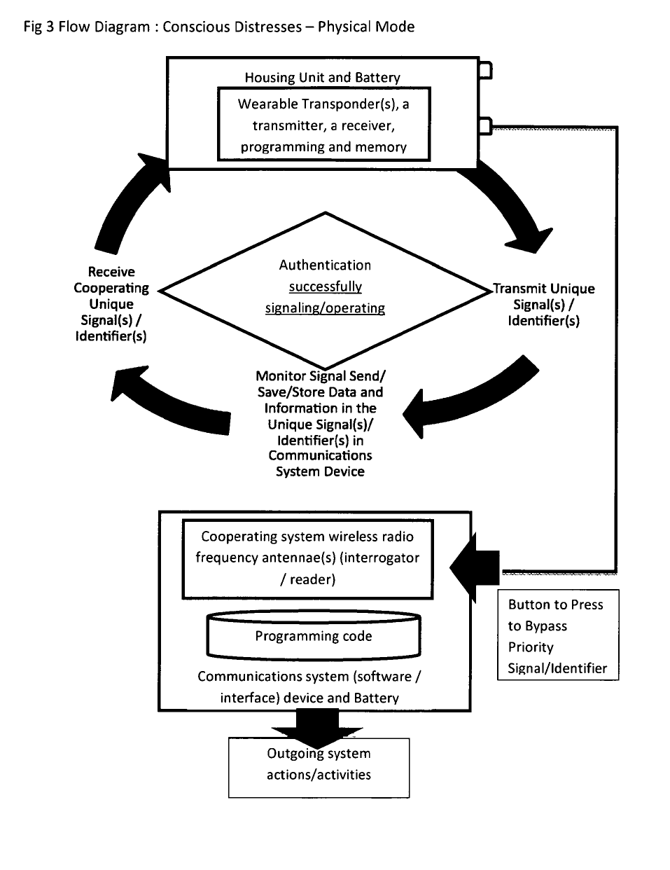

FIG. 4 When the cooperating wireless antennae radio (read/interrogator) device and the wearable transponders is not successfully detecting signal within the programmed signal range and signal the unique signal(s)/unique identifier(s), where data and information programmed in the signals have stopped transmitting and receiving and where the communications system (software and/or interface) is no longer reading/writing/saving/storing the data and information in real-time or intermittently. The communications systems will prompt/message the wearer with prompt/message in the communications system device regarding the unsuccessful operations of the system. If the wearer does not respond—within a programmed time limit—to the prompts/messages the communications will begin a series of programmed actions/activities to wearer's communication network, such as sending outgoing actions/activities enabled in the communications system device to aid and to respond in the event of a personal safety event(s). An unresponsive wearer could indicate: the wearer is unconscious; the wearer's communications system device and/or transponder have been separated in an attack or an accident; the wearer is knowingly allowing the system to cycle through automatic outgoing actions/activities because she/he wants to conceal signaling

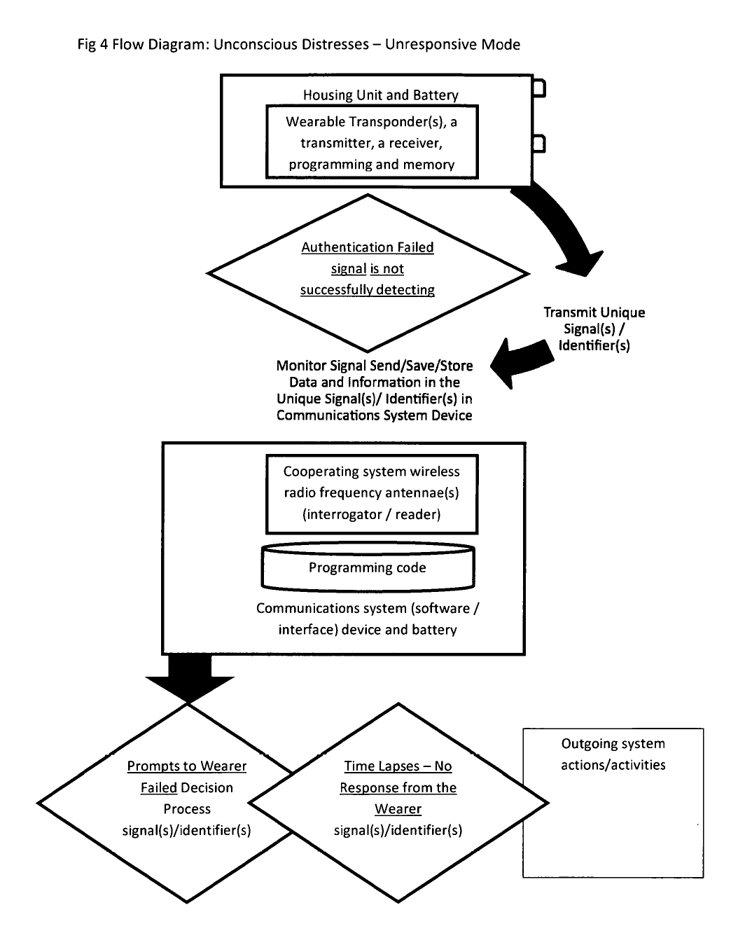

### BEST MODE FOR CARRYING OUT THE INVENTION

In accordance with 35.U.S.C. 112(a), the below text and visuals demonstrate the requirements for Best Mode:

The portable wearable transponder(s) is worn by a person to monitor data and information in real-time or intermittently (based on programming), using unique signal(s) and/or unique identifier(s) that transmit and receive to nearby cooperating wireless radio frequency antennae(s) in his/her communications system device in the event the wearer needs to request aid and/or a response in the event of a personal safety event. Data and information can be programmed (encoded) in unique signal(s) and/or unique identifier(s) and/or saved/stored for accessibility by the communications system device in preparation for the wearer to access his/her safety network in the event(s) of the wearer is unresponsive, distressed, being attacked, threatened, in danger and/or facing an emergency: environmental, medical, mental and/or physical).

### How it Works

If the cooperating wireless radio frequency antennae(s) detects the transponders' signals range is exceeding the programmed thresholds or the transponders' are surpassing the signal strength limits (below programming thresholds), the cooperating wireless radio frequency antennae(s) will communicate the transponders' data/information (location, GPS coordinates, and time, as well as other saved/stored date) through the communications system (software/interface) device to the wearer, and prompt the wearer in a series of commands/prompts/messages (e.g. to move within signal range of the antennae(s) to increase signal strength). Within a programming timeframe, the wearer can take activities/actions through the communications system (software/interface) device, such as initiate, activate, and/or deactivate the transponder by pressing a button. In the absence of a recognized response from the wearer, the communications system device will automatically begin programmed actions/activities. A failure to respond could indicate an unresponsive wearer or that the wearer desires to conceal his/her intentions to signal an emergency from others by allowing the prompts to escalate, in which case the communications (software/interface) device automatically initiate/activate/deactivate activities/actions, based on programming—independently of the wearer.

The wearer can initiate a priority signal by pressing on a button on the portable wearable the transponder(s), bypassing the authentication process of the cooperating wireless radio frequency antennae and interrupts the current initiate/activate/deactivate activities/actions to expedite priority unique signal/unique identifier signal for immediate initiate/activate/activities/actions.

1-23. (canceled)

24. A wearable personal safety device comprising:
a housing unit having skin contact and including a radio frequency transponder configured to:
receive, from a mobile communication device, an initiating signal including a unique user identifier and establish a connection therewith, the transponder being configured to detect biometric and physiological parameter values of the skin,
memory configured to store data indicative of the detected biometric and physiological parameter values,
a rechargeable battery, and
a processor configured to, in response to one of the detected biometric and physiological parameter values not meeting a corresponding threshold, cause the transponder to send to the communication device a request, including the unique identifier, to issue a personal emergency alert.

25. The device of claim 24, wherein the transponder is further configured to, upon establishing the connection with the communication device, maintains the connection by periodically sending the detected biometric and physiological parameter values to the communication device.

26. The device of claim 24, wherein the request to issue the alert is in response to several detected biometric and physiological parameter values not meeting the corresponding thresholds.

27. The device of claim 24, wherein the issuance of the alert is further in response to an absence of user input to a user prompt.

28. The device of claim 27, wherein the issuance of the alert is in response to an absence of user input to at least one of a plurality of prompts arranged in a sequence of increasing urgency.

29. The device of claim 24, wherein the signal request to the communication device, from the transponder, further includes a date and time of the sending and geographic location of the personal safety device.

30. The device of claim 29, wherein the signal request to the communication device, from the transponder, further includes a distance traveled to the location, a travel time to the location, or a length of stay at the location.

31. A wearable device comprising:
a housing unit including a radio frequency transponder configured to initiate detecting biometric parameter values of skin proximate to the housing unit in response to receiving an initiation signal including a unique user identifier from a mobile communication device,
memory configured to store data indicative of the detected biometric parameter values,
a rechargeable battery, and
a processor configured to, in response to several values not meeting corresponding thresholds, send to the communication device a request to issue a personal emergency alert.

32. The device of claim 31, wherein the communication device is configured to, in response to the request, generate a plurality of user prompts and issue the alert when failing to receive user input to the prompts.

33. The device of claim 32, wherein the prompts are arranged in a sequence of increasing urgency.

34. The device of claim 31, wherein the communication device is configured to prioritize the issuance of the alert over at least one of receiving another signal, sending another signal, and performing a device operation unrelated to the issuance.

35. The device of claim 31, wherein the request includes a date and time of the sending and geographic location of the wearable device.

36. The device of claim 35, wherein the signal request to the communication device, from the transponder, further includes a distance traveled to the location, a travel time to the location, or a length of stay at the location.

37. The device of claim 31, wherein the signal request to the communication device, from the transponder, request includes a unique identifier and the initiation of the alert is in response to the identifier corresponding to a previously-stored identifier of the communication device.

38. A personal safety system comprising:
a mobile communication device including a wireless radio frequency antenna; and
a wearable device including a housing unit proximate to the skin, a transponder configured to establish communication with the communication device to receive interval signals therefrom and detect biometric parameter values of the skin,
a rechargeable battery, and
a processor configured to, in response to each interval signal, cause the transponder to send to the communication device a corresponding return interval signal including the detected biometric values, such that the communication device issues a personal emergency alert when the communication device fails to receive the return interval signal including the values.

39. The device of claim 38, wherein the issuing is further in response to absence of user input requested via a plurality of generated user prompts arranged in a sequence of escalating urgency.

40. The device of claim 38, wherein the issuing includes prioritizing sending of the alert signal over receiving or sending of another signal.

41. The device of claim 38, wherein each return interval signal includes a date and time of the sending of the return interval signal and geographic location of the wearable device and the alert includes the date, time, and location included in a last received return interval signal.

42. The device of claim 41, wherein the alert further includes distance traveled to the location, a travel time to the location, or a length of stay at the location included in a last received return interval signal.

43. The device of claim 38, wherein each return interval signal includes a unique identifier and the alert is in response to the identifier of a last received interval signal corresponding to a previously-stored identifier of the communication device.
